(19) United States
(12) Patent Application Publication
(10) Pub. No.: US 2023/0244574 A1
(43) Pub. Date: Aug. 3, 2023

(54) MANUAL SNAPSHOT AND RESTORE OF USER APPLICATIONS HOSTED ON CLOUD INFRASTRUCTURES

(71) Applicant: Nutanix, Inc., San Jose, CA (US)

(72) Inventors: Santhosh Kumar Vijayan, Coimbatore (IN); Sampanna Hegde, Sirsi (IN); Pranav Gupta, Jaipur (IN); Esha Doda, Bangalore (IN)

(21) Appl. No.: 18/051,014

(22) Filed: Oct. 31, 2022

(30) Foreign Application Priority Data
Feb. 1, 2022 (IN) 202241005434

(51) Int. Cl. G06F 11/14; G06F 16/11

(52) U.S. Cl. CPC G06F 11/1469; G06F 16/128; G06F 2201/84; G06F 2201/815

(57) ABSTRACT

An aspect of the present disclosure facilitates manual snapshot and restore of user applications hosted on cloud infrastructures. In one embodiment, a system receives setup data specifying a first set of actions (such as shutting off and restarting related services, etc.) to be performed upon receipt of a manual snapshot command with respect to a component of a user application hosted on a cloud infrastructure. Upon receiving the manual snapshot command to capture a current state of the component, the system performs the first set of actions along with capturing the current state of the component.

### PRIORITY CLAIM

The instant patent application is related to and claims priority from the co-pending India provisional patent application entitled, “MANAGEMENT OF USER APPLICATIONS HOSTED ON CLOUD INFRASTRUCTURES”, Serial No.: 202241005434, Filed: 1 Feb. 2022 (hereinafter “provisional application”), which is incorporated in its entirety herewith.

### BACKGROUND OF THE DISCLOSURE

### Technical Field

The present disclosure relates to cloud computing and more specifically to manual snapshot and restore of user applications hosted on cloud infrastructures.

### Related Art

Cloud infrastructure refers to a collection of processing nodes, connectivity infrastructure, data storages, etc., which can be engineered to together provide a corresponding virtual computing infrastructure for various customers, with the scale of each computing infrastructure being specified often on demand.

User applications are often hosted on respective cloud infrastructures. Each user application processes requests received from users, and provides corresponding responses. A user application may rely on various computing, networking and storage capabilities provided by the cloud infrastructures.

Combination of snapshot and restore operations are often used in association with such user applications. Snapshot operation generally entails making a copy of the state of the user application (including any components thereof) at a specific time instance, and a restore operation uses the copy to bring the user application back to the state corresponding to the specific time instance.

There are situations when such snapshot and restore operations are required to be performed manually, for example, when an administrator of a cloud infrastructure or a user application wishes to perform administrative actions/commands such as patching or upgrading the user application. Manual performance implies that the snapshot operation is initiated immediately as desired by the administrator, which is contrasted with scheduled initiations that may be performed by software programs such as those implementing disaster recovery.

Aspects of the present disclosure are related to such manual snapshot and restore of user applications hosted on cloud infrastructures.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2A illustrates an example execution state within a node of a cloud infrastructure.

FIG. 2B illustrates the manner in which clouds (and correspondingly user applications) are deployed in cloud infrastructures in one embodiment.

FIG. 3 is a flow chart illustrating the manner in which manual snapshot and restore of user applications hosted on cloud infrastructures is facilitated according to aspects of the present disclosure.

FIGS. 4A and 4B together depict the manner in which a user (application deployer) is facilitated to specify the setup of a user application hosted in a cloud infrastructure in one embodiment.

FIGS. 5A-5E illustrates the manner in which a user (application deployer) is facilitated to specify a set of actions to be performed for manual snapshot and restore of components of a user application according to an aspect of the present disclosure.

FIGS. 6A-6D illustrates the manner in which setup data for a user application is specified in one embodiment.

FIGS. 7A and 7B illustrates the manner in which a user (operator) is facilitated to perform manual snapshot and restore of components of a user application in one embodiment.

FIG. 8 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates manual snapshot and restore of user applications hosted on cloud infrastructures. In one embodiment, a system receives setup data specifying a first set of actions (such as shutting off and restarting related services, etc.) to be performed upon receipt of a manual snapshot command with respect to a component of a user application hosted on a cloud infrastructure. Upon receiving the manual snapshot command to capture a current state of the component, the system performs the first set of actions along with capturing the current state of the component.

According to another aspect of the present disclosure, the user application includes multiple components including the component noted above, with each component being hosted on a respective virtual machine in the cloud infrastructure. A first action of the first set of actions (noted above) is performed with respect to a first component, the first component being different from the component.

According to one more aspect of the present disclosure, a second action of the first set of actions (noted above) is performed with respect to a second component of the user application, the second component being different from the first component and the component (noted above). The performing of the first set of actions comprises executing a script to perform the first set of actions, including the first action and the second action on the respective virtual machines.

According to yet another aspect of the present disclosure, the setup data is part of a blueprint file provided by an application deployer and the manual snapshot command is received from an operator (such as cloud infrastructure administrator or user application administrator).

According to an aspect of the present disclosure, the setup data further specifies a second set of actions to be performed upon receipt of manual restore commands with respect to the component. Upon receiving, after receipt of the setup data, a first manual restore command to restore the component to a previous state captured in a corresponding snapshot, the system (noted above) performs the second set of actions along with restoring the component to the previous state.

According to one more aspect of the present disclosure, all of the first set of actions are performed before performing the capturing of the current state of the component. Also, all of the second set of actions are performed after performing the restoring of the component to the previous state. In one embodiment, the component is the user application.

Aspects of the present disclosure can accordingly facilitate persons such as an operator/administrator to merely invoke the manual snapshot command, with the requisite (first set of) actions being performed according to the setup data specified in a blueprint file.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

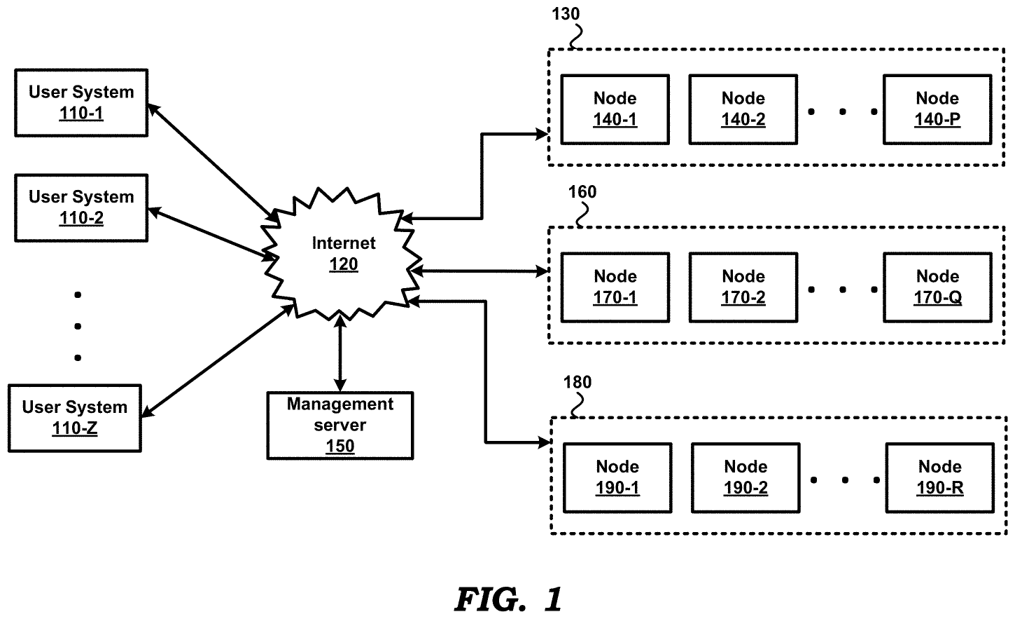

FIG. 1 is a block diagram illustrating an example environment (computing system) in which several aspects of the present disclosure can be implemented. The block diagram is shown containing user systems 110-1 through 110-Z (Z representing any natural number), Internet 120, management server 150, and cloud infrastructures 130, 160 and 180. Cloud infrastructure 130 in turn is shown containing nodes 140-1 through 140-P (P representing any natural number). Cloud infrastructure 160 in turn is shown containing nodes 170-1 through 170-Q (Q representing any natural number). Cloud infrastructure 180 in turn is shown containing nodes 190-1 through 190-R (R representing any natural number). The user systems and nodes are collectively referred to by 110, 140, 170 and 190 respectively.

Merely for illustration, only representative number/type of systems is shown in FIG. 1. Many environments often contain many more systems, both in number and type, depending on the purpose for which the environment is designed. Each block of FIG. 1 is described below in further detail.

Each of cloud infrastructures 130, 160 and 180 is a collection of processing nodes (140, 170 and 190), connectivity infrastructure, data storages, administration systems, etc., which are engineered to together provide a virtual computing infrastructure for various customers, with the scale of such computing infrastructure being specified often on demand. Cloud infrastructure 130/160/180 may be one of Amazon Web Services (AWS) Cloud available from Amazon.com, Inc., Google Cloud Platform (GCP) available from Google LLC, Azure cloud available from Microsoft, Inc., Xi cloud available from Nutanix etc., or a private cloud such as an On-Premises cloud owned by the customers/tenants.

All the systems of each cloud infrastructure 130/160/180 are assumed to be connected via an intranet (not shown). Internet 120 extends the connectivity of these (and other systems of the cloud infrastructures) with external systems such as user systems 110 and management server 150. Each of intranet and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranets. When the packet contains content such as port numbers, which specifies a target application, the packet may be said to be directed to such application as well.

Each of user systems 110 represents a system such as a personal computer, workstation, mobile device, computing tablet etc., used by users to generate (user) requests directed to enterprise/user applications executing in cloud infrastructures 130/160/180. The user requests may be generated using appropriate user interfaces (e.g., web pages provided by a user application executing in a node, a native user interface provided by a portion of a user application downloaded from a node, etc.).

In general, a user system requests a user application for performing desired tasks and receives the corresponding responses (e.g., web pages) containing the results of performance of the requested tasks. The web pages/responses may then be presented to the user by local applications such as the browser. Each user request is sent in the form of an IP packet directed to the desired system or user application, with the IP packet including data identifying the desired tasks in the payload portion.

Some of nodes 140/170/190 may be implemented as corresponding data stores. Each data store represents a non-volatile (persistent) storage facilitating storage and retrieval of data by user applications executing in the other systems/nodes of cloud infrastructures 130/160/180. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 140/170/190 may be implemented as corresponding server systems. Each server system represents a server, such as a web/application server, executing enterprise applications (examples of user applications) capable of performing tasks requested by users using user systems 110. A server system receives a user request from a user system and performs the tasks requested in the user request. A server system may use data stored internally (for example, in a non-volatile storage/hard disk within the server system), external data (e.g., maintained in a data store/node) and/or data received from external sources (e.g., from the user) in performing the requested tasks. The server system then sends the result of performance of the tasks to the requesting user system (one of 110) as a corresponding response to the user request. The results may be accompanied by specific user interfaces (e.g., web pages) for displaying the results to the requesting user.

In one embodiment, each customer/tenant is provided with a corresponding virtual computing infrastructure (referred to as a “cloud”) provisioned on the nodes of cloud infrastructures 130, 160 and 180. The virtual infrastructure contains computing resources (e.g., virtual machines, operating systems hosted on VMs), network resources (e.g., public IP addresses) and storage resources (e.g., database systems, file systems). Each tenant may deploy desired user applications/data services on the resources provided as a part of their cloud(s), with the services being capable of processing user requests received from user systems 110.

In general, it may be appreciated that the term provisioning of an execution entity (user application, VM, etc.) implies allocation of resources for the execution entity in a node of the cloud infrastructure. The term hosting of an execution entity implies that the execution entity is ready for execution, and such hosting entails loading of an image data corresponding to the execution entity into a memory, allocating of external resources such as network/IO ports for the hosted execution entity, and configuring the hosted execution entity (assuming that the image data is not of a preconfigured version). The term deploying of an execution entity implies provisioning, hosting and execution of the software instructions of the loaded image.

The manner in which user applications may be deployed in a cloud infrastructure (such as 130/160/180) is described below with examples.

### 3. Deploying User Applications in a Cloud Infrastructure

It may be appreciated that each user application may be deployed based on application components hosted on nodes of a cloud infrastructure. An application component represents an execution entity forming a part of the user application, and can be one of an application service or an infrastructure component. An application may be constituted of a single component itself. An application service is an executing entity/process delivering (to users) one or more of the intended functionalities of the user application. An infrastructure component on the other hand represents a shared resource that may be used by multiple application components. Examples of infrastructure components include but are not limited to operating systems, software containers such as kubernetes™, etc.

Deployment of user applications may require configuration of the components of the user application. As is well known, configuration of a component entails setting the values of pre-specified parameters such as vCPU, memory, number of connections in a connection pool, maximum number of threads, etc. Upon execution of the user application, it may be appreciated that each component may be in different execution states such as stopped, ready for execution, executing, etc.

In one embodiment, clouds containing virtual machines (VMs) form the basis for deployment of various user/enterprise applications in the nodes of cloud infrastructures 130/160/180. As is well known, a virtual machine may be viewed as a container in which other execution entities are executed. A node/server system can typically host multiple virtual machines, and the virtual machines provide a view of a complete machine (computer system) to the user applications executing in the virtual machine.

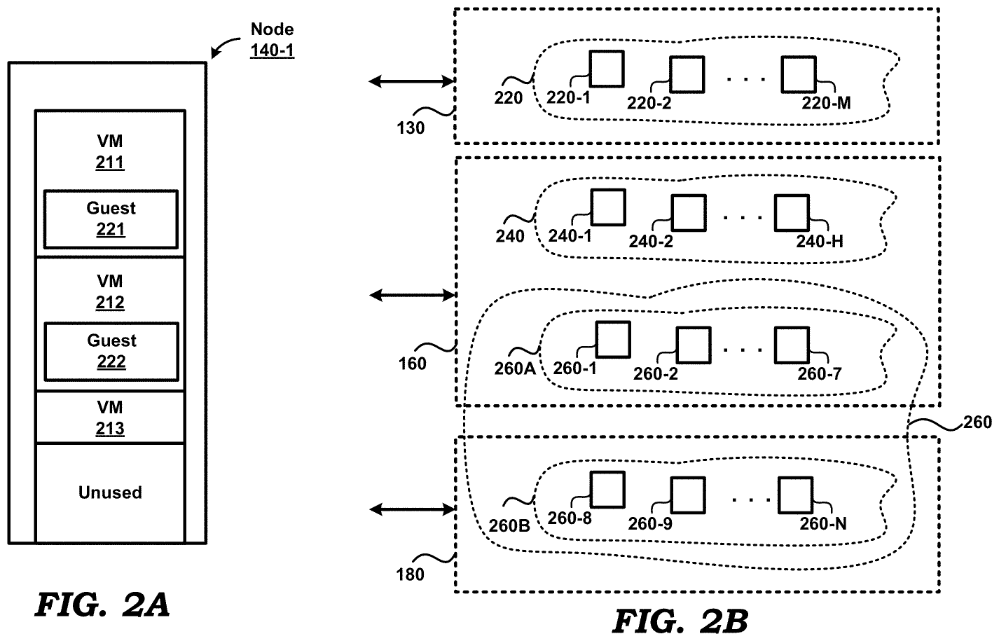

FIG. 2A illustrates an example execution state within a node of a cloud infrastructure. Node 140-1 is shown provisioned with, and accordingly hosting VMs 211, 212, 213, with the resources of the node shown allocated among the three VMs and some resources shown as still remaining ‘unused’ (i.e., not provisioned for any execution entity within node 140-1). Some of VMs 211-213 is shown hosting guest (modules) 221 and 222. Guest modules 221/222 may correspond to one of an application service or infrastructure component provided as part of the user application deployed in cloud infrastructure 130. Similarly, other VMs may be hosted in the other nodes of cloud infrastructures 130/160/180 and form the basis for deploying user applications in those cloud infrastructures.

FIG. 2B illustrates the manner in which clouds (and correspondingly user applications) are deployed in cloud infrastructures in one embodiment. Specifically, the Figure illustrates the manner in which clouds 220, 240 and 260 are deployed in the nodes of cloud infrastructures 130/160/180 using VMs. Only a sample set of clouds is shown in FIG. 2B for illustration, though many environments often host a large number (100+) clouds across multiple cloud infrastructures.

Cloud 220 is shown containing VMs 220-1 through 220-M (M representing any natural number) that may be provisioned on the different nodes 140 of cloud infrastructure 130, while cloud 240 is shown containing VMs 240-1 through 240-H (H representing any natural number) that may be provisioned on the different nodes 170 of cloud infrastructure 160.

Cloud 260 is shown containing VMs provisioned on some of nodes 170 and also in some of nodes 190. Cloud 260 may accordingly be viewed as a “hybrid” cloud provisioned across the nodes of multiple cloud infrastructures (160 and 180). Specifically, groups 260A and 260B respectively represents the set of VMs provisioned in cloud infrastructures 160 and 180.

A customer/tenant owning a cloud (e.g., 220) may deploy desired user applications for execution in the cloud. For example, a user may deploy a LAMP (Linux operating system, Apache HTTP Server, MySQL relational database management system, and PHP programming language) based ERP (enterprise resource planning) application (example of a user application) on three VMs 220-1, 220-2 and 220-3 which in turn are hosted on nodes 140 in cloud infrastructure 130. Post deployment, during operation (processing of user requests) of the user application, the customer may wish to manage the user (LAMP/ERP) application hosted on cloud infrastructure 130.

In the following description, the term “application deployer” is used for a user who deploys the user application components in cloud infrastructures and also specifies a setup data indicating the details of the deployed user application. The term “operator” is used for a user/administrator who manages the user application post-deployment during operation of the user application or a user/administrator who manages the underlying computing infrastructure.

Management server 150, provided according to several aspects of the present disclosure, facilitates to manual snapshot, and restore of user applications hosted on cloud infrastructures (such as 130/160/180). Though management server 150 is shown external to cloud infrastructures 130/160/180, in alternative embodiments, management server 150 may be implemented internal to one of cloud infrastructures 130/160/180, for example, in one of nodes 140/170/190. The manner in which management server 150 facilitates to manual snapshot and restore of user applications is described below with examples.

### 4. Manual Snapshot and Restore of User Applications

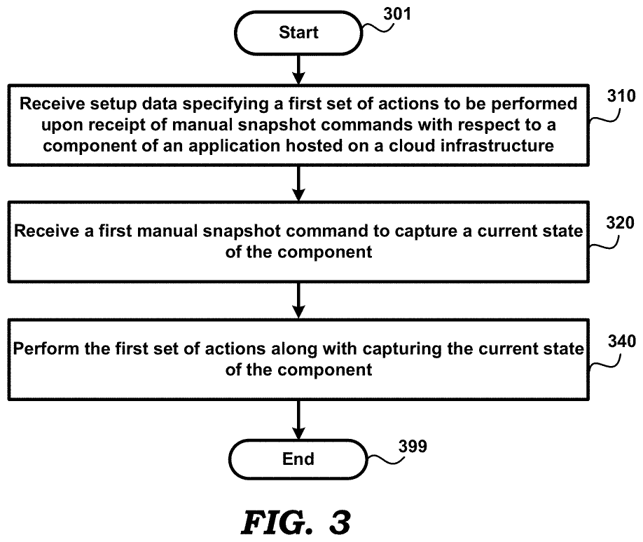

FIG. 3 is a flow chart illustrating the manner in which manual snapshot and restore of user applications hosted on cloud infrastructures is facilitated according to aspects of the present disclosure. The flowchart is described with respect to the systems of FIGS. 1 and 2, in particular node manager 150, merely for illustration. However, many of the features can be implemented in other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 301, in which control immediately passes to step 310.

In step 310, management server 150 receives setup data specifying a first set of actions to be performed upon receipt of manual snapshot commands with respect to a component (application or infrastructure) of a user application hosted on a cloud infrastructure (assumed to be 130 for illustration). The setup data may be received from one of user systems 110.

In the instant disclosure, actions affect one or both of configuration and execution state of components of the user application. Some actions may affect the configuration of the components by setting the pre-defined parameters to desired/user specified values. Some other actions may affect the execution state of the components, typically by stopping the components. According to an aspect, one of the actions is performed with respect to another component different from the component noted above.

The received setup data may be stored for later access in a non-volatile storage either provided internally (for example, in a hard disk within management server 150) or in an external data store (not shown in FIG. 1) associated with management server 150. The setup data may be received and stored in any convenient format, such as, a file or a table in a database server according to relational database technologies.

In step 320, management server 150 receives a first manual snapshot command to capture a current state of the component. The manual snapshot command may be received from one of user systems 110 after receipt of the setup data in step 310.

In step 340, management server 150 performs the first set of actions along with capturing the current state of the component. In other words, the capturing operation is performed in addition to the first set of actions. The first set of actions is identified by inspecting the setup data received in step 310 (or stored in a non-volatile storage). As noted above, performance of the actions may affect one or both of configuration and execution state of the component. The captured current state of the component may be stored in a non-volatile storage (not shown) and is referred to as a snapshot, as is well known in the arts. Control passes to step 399, where the flowchart ends.

Though described above with respect to a single component, it may be appreciated that in a typical implementation, setup data includes respects sets of actions corresponding to the manual snapshot commands with respect to different components of the user application. According to an aspect, the setup data further specifies a second set of actions to be performed upon receipt of manual restore commands with respect to the component. Accordingly, upon receiving, after receipt of the setup data, a first manual restore command to restore the component to a previous state captured in a corresponding snapshot, management server 150 performs the second set of actions along with restoring the component to the previous state.

According to another aspect, all of the first set of actions are performed before performing the capturing of the current state of the component, and all of the second set of actions are performed after performing the restoring of the component to the previous state.

According to one more aspect, the setup data is received (in step 310) in the form of a blueprint file provided by an application deployer of the user application, while the manual snapshot command is received (in step 320) from an operator (user application administrator or cloud infrastructure administrator) as part of maintenance of the user application. It may be appreciated that the specific set of actions to be performed for manual snapshot commands may be determined by the application deployer based on the architecture of the user application. As such, aspects of the present disclosure shield the operators from the details of the architecture of the user application.

Thus, management server 150 facilitates manual snapshot and restore of user applications hosted on cloud infrastructures. The manner in which management server 150 provides several aspects of the present disclosure according to the steps of FIG. 3 is illustrated below with examples.

### 5. Illustrative Example

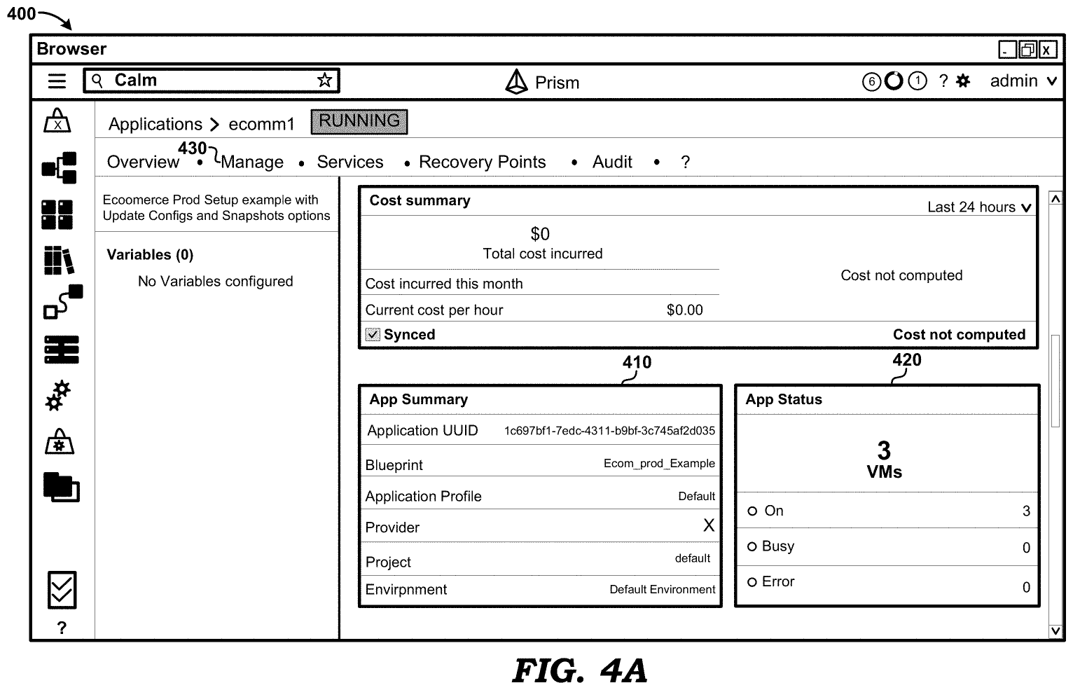

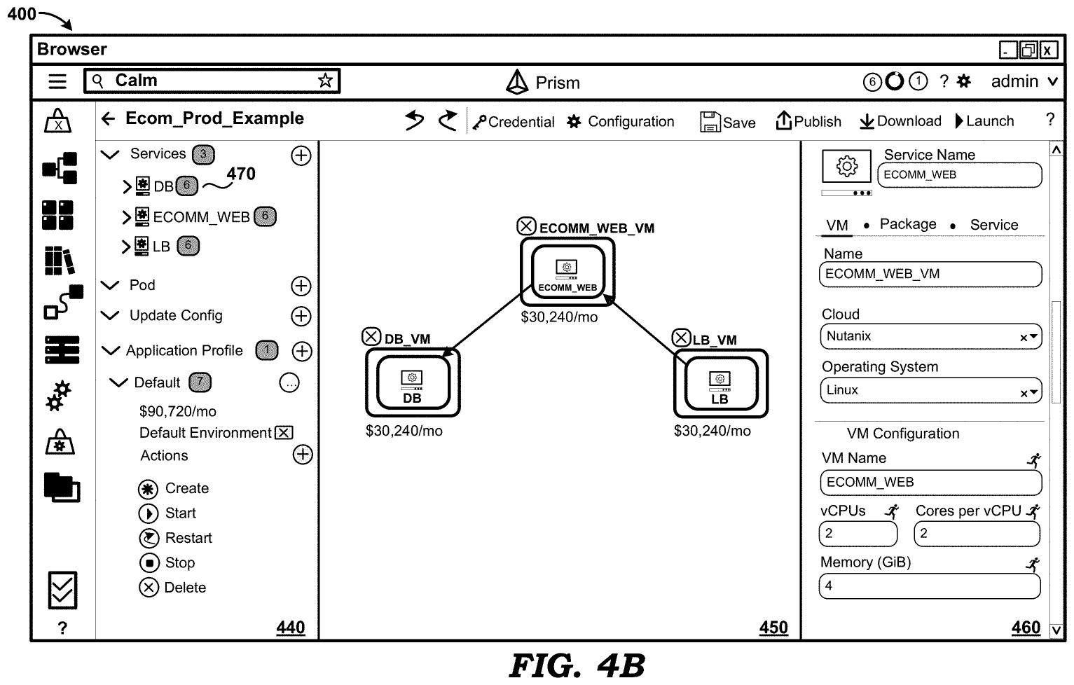

FIGS. 4A-4B, 5A-5E, 6A-6D and 7A-7B together illustrate the manner in which manual snapshot and restore of user applications hosted on cloud infrastructures is facilitated in one embodiment. Each of the Figures is described in detail below.

FIGS. 4A and 4B together depict the manner in which a user (application deployer) is facilitated to specify the setup of a user application hosted in a cloud infrastructure in one embodiment. Display area 400 (and display areas 500 and 700) represents a portion of a user interface displayed on a display unit (not shown) associated with one of user systems 110.

In one embodiment, display area 400 corresponds to a web page rendered by a browser executing on a user system. The web pages may be provided by management server 150 in response to a user (such as an application deployer, operator, etc.) sending appropriate requests (for example, by specifying corresponding Uniform Resource Locator (URL) in the address bar) using the browser. Display area 400 of FIG. 4A (and also display area 500) accordingly depicts a portion of a user interface displayed in the browser (executing in user system 110-1, for illustration) in response to a user specifying a corresponding URL.

In FIG. 4A, display area 410 indicates that the user (application deployer) is specifying the setup data for an E-commerce product application (named “Ecom_Prod_Example”), while display area 420 indicates that the components of the E-commerce product application is hosted on 3 VMs. The user may select the “Manage” option (display area 430) to cause the display of the display area 400 of FIG. 4B.

In FIG. 4B, display area 440 enables the user (application deployer) to specify the details of various administrative commands (“Update Config”, “Application Profiles”, etc.) that can be performed by an operator. Display area 460 enables the user to specify the details of the administrative commands selected from display area 440 and also the details of the components (such as “DB”, “ECOMM_WEB”). For example, display area 460 of FIG. 4B enables the user to specify the details of a service (application component), any underlying packages (infrastructure components) required for execution of the service, and any VMs required for execution of the service and/or package/infrastructure component.

Display area 450 depicts a pictorial/graphical representation of the various services/components of the user application and the corresponding VMs hosting the components. In particular, display area 450 depicts three rounded rectangles representing the three components of the user application, that is, LB, ECOMM_WEB and DB. Each component is shown hosted on a corresponding VM, that is, LB_VM, ECOMM_WEB_VM and DB_VM, shown as rounded rectangles surrounding the rounded rectangles representing the components. Arrows linking the displayed rectangles indicate the dependencies among the components, with the component at the start of the arrow being the dependent component and the component at the end/pointed tip of the arrow indicating the base component. Though not explicitly shown, it may be appreciated that dependencies also exist between the services and the underlying infrastructure components (not shown).

Thus, management server 150 facilitates an IT administrator to specify the details of the setup of a user application hosted on a cloud infrastructure. According to several aspects of the present disclosure, management server 150 also facilitates the user/application deployer to specify desired actions (such as shutting off and restarting related services, etc.) to be performed when manual snapshot and restore commands are issued by an operator. The manner in which a user is enabled to specify the actions for manual snapshot and restore is described below with examples.

### 6. Specifying Actions for Manual Snapshot and Restore

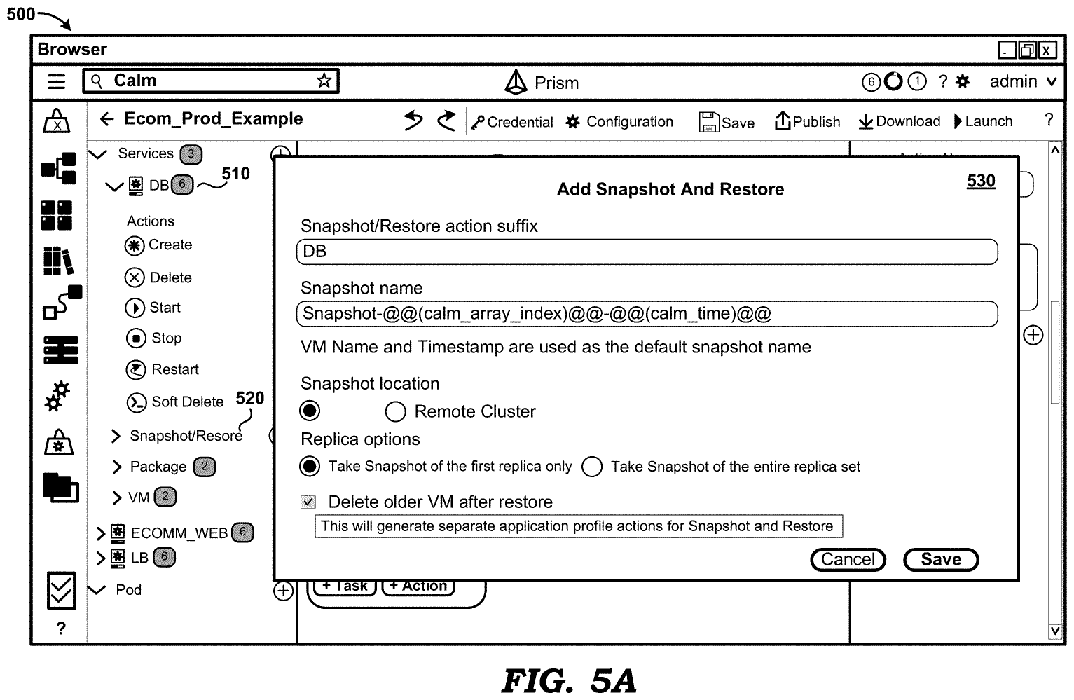

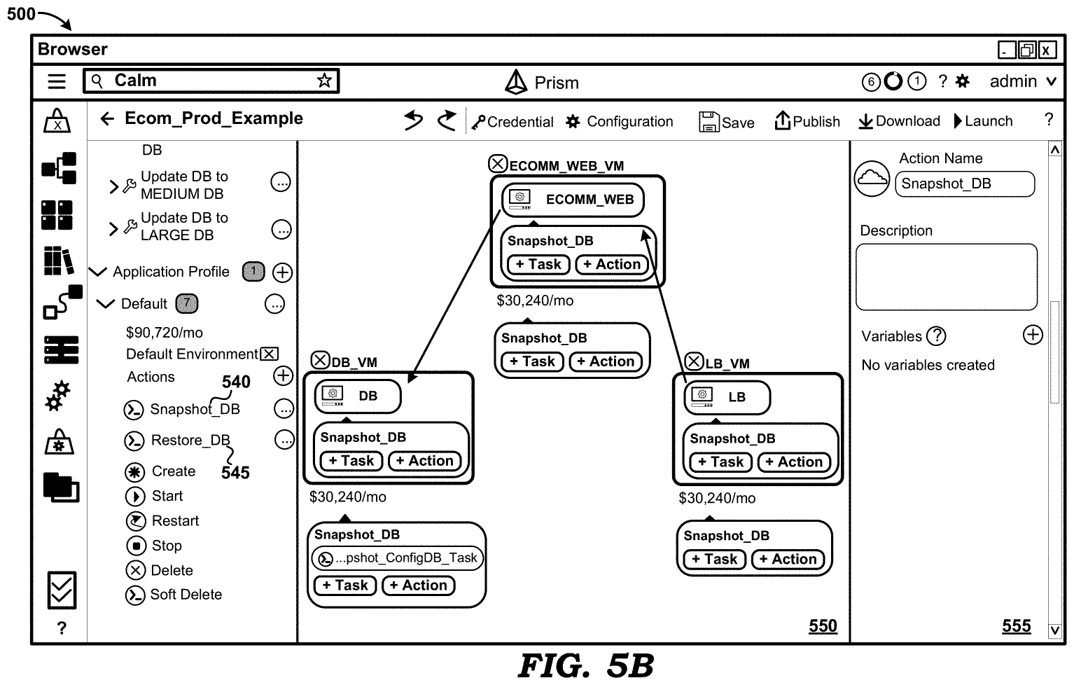

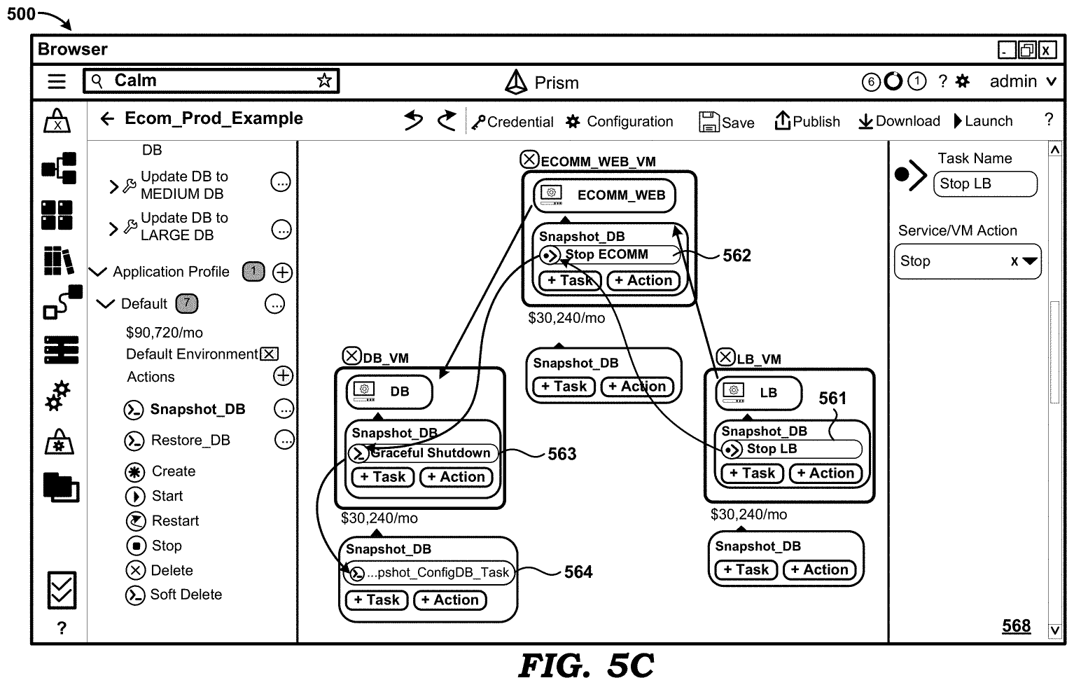

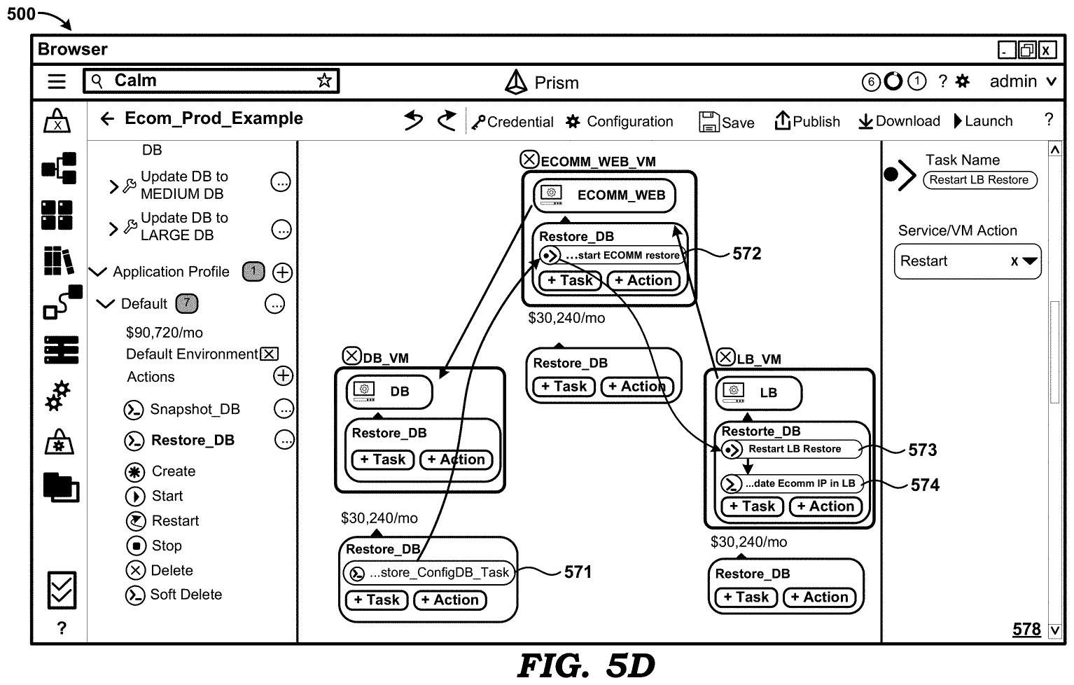

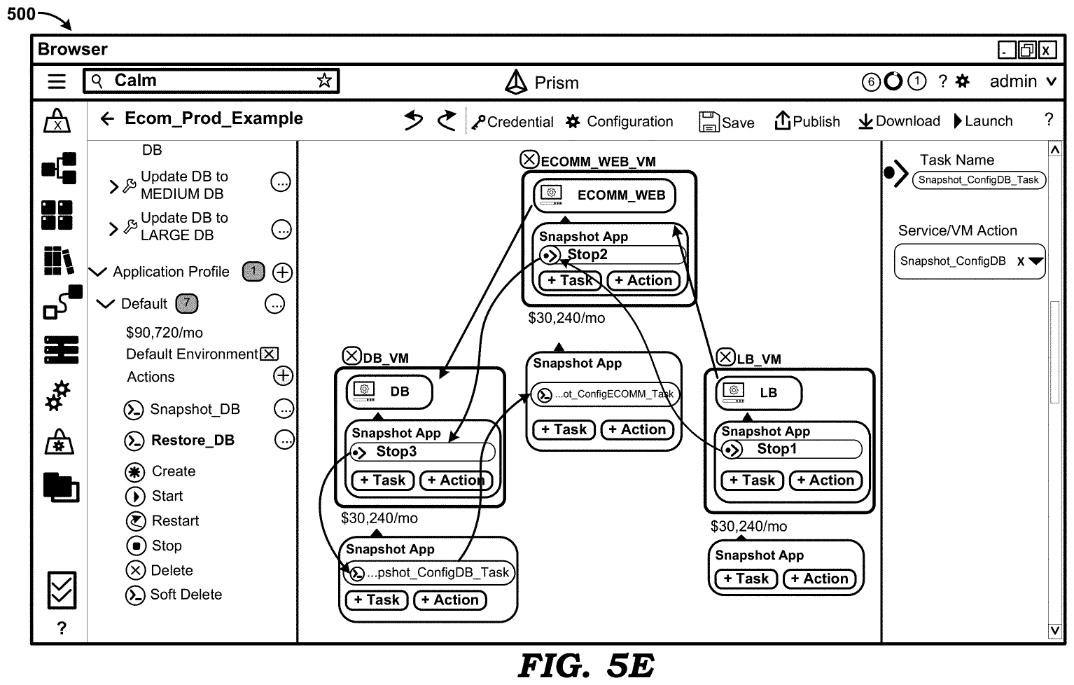

FIGS. 5A-5E illustrates the manner in which a user (application deployer) is facilitated to specify a set of actions to be performed for manual snapshot and restore of components of a user application according to an aspect of the present disclosure. Each of the Figures is described in detail below.

In FIG. 5A, display area 500 depicts the manner in which a user (application deployer) specifies the snapshot configuration of a specific component (“DB”). The user may click/select display area 510 (“DB”) to see the options displayed below display area 510 and thereafter select display area 520 (“Snapshot/Restore”) to cause the pop-up of display area 530 to be displayed. The user may specify the details of the snapshot/restore in display area 530 such as the name of the snapshot, the location at which the snapshots are to be stored, etc. and select “Save” in display area 530 to cause a new snapshot/restore command to be added and made available to the operator.

In FIG. 5B, display area 500 indicates the various snapshot configurations specified by an application deployer for the “DB” component of the user application. Specifically, displays areas 540 and 545 indicates that the configurations include “Snapshot_DB”, and “Restore_DB”. Display area 555 indicates that the configuration “Snapshot_DB” is currently being edited by the user. Accordingly, each of the rectangle in display area 550 is shown containing another inner rectangle corresponding to the “Snapshot_DB” configuration. It may be observed that each of the inner rectangles includes two options “+ Task” and “+ Action” which respectively enable a user to add a task or an action (a set of tasks) to be performed as part of the “Snapshot_DB” configuration. It should be noted that the tasks/actions specified herein correspond to the actions to be performed upon receipt of the manual snapshot and restore commands.

In FIG. 5C, display area 500 illustrates the manner in which the user specifies the set of actions to be performed as part of a snapshot/restore configuration (here, “Snapshot_DB”). Display areas 561, 562, 563 and 564 indicate the details of the tasks/actions to be performed associated with different components of the user application when a manual snapshot of the DB component is received. It may be observed that actions 561-564 are shown interconnected by directed (curvy) arrows, with the direction of the arrows indicating a corresponding execution order for the tasks. In other words, tasks 561-564 specifies a sequence of actions to be performed. Display area 568 enables the user to specify the details of the tasks/actions. For example, display area 568 indicates that the “Stop LB” task is to stop the service “LB” and associated VM “LB_WM”.

Thus, a user (application deployer) is facilitated to specify a sequence of actions to be performed for manual snapshot of a component (“DB”) of a user application (“Ecom_Prod_Example”). The user may similarly specify the sequence of actions to be performed for manual restore of the component (“DB”).

In FIG. 5D, display area 500 depicts the manner in which a user (application deployer) specifies the restore configuration of a specific component (“DB”). Display areas/tasks 571-574 represents the sequence of actions to be performed for manual restore of a component (“DB”) of a user application (“Ecom_Prod_Example”). Display area 578 enables the user to specify the details of the tasks/actions (such as “Restart LB Restore” shown there). It may be appreciated that the user may similarly specify desired sequences of actions to be performed for manual snapshot/restore for other components of the user application. FIG. 5E depicts the manner in which a user (application deployer) specifies the snapshot configuration of the user application (“Snapshot App”).

Thus, a user is facilitated to specify a corresponding set of actions to be performed for manual snapshot and restore of components of a user application. The set of actions may be specified as part of a setup data as described below with examples.

### 7. Setup Data

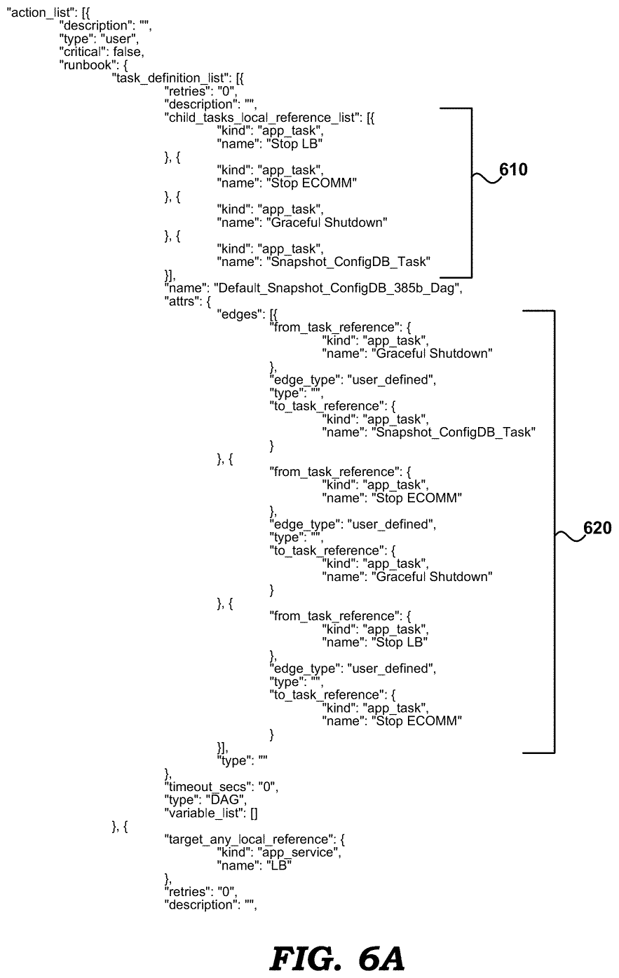

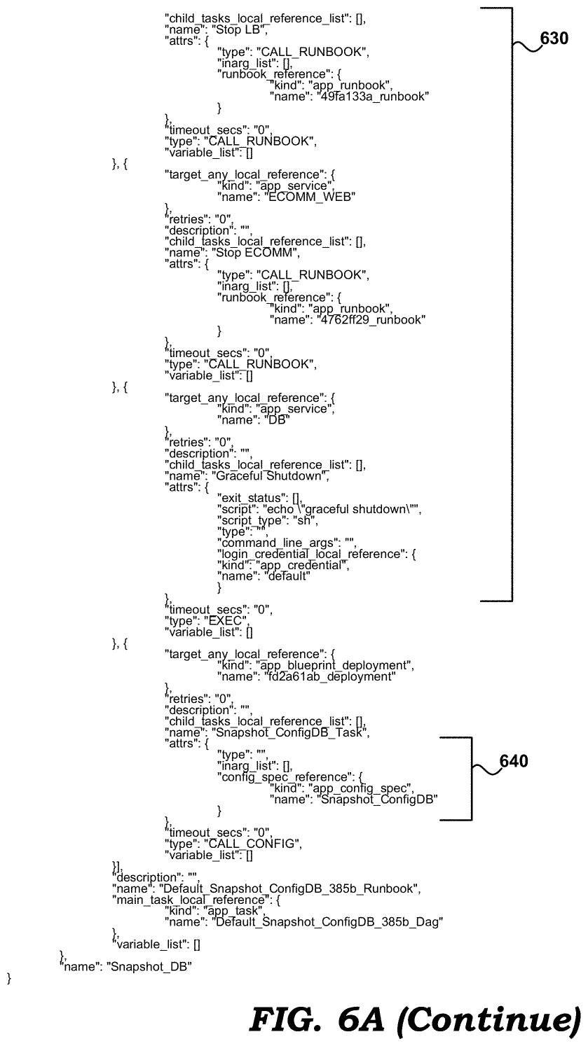

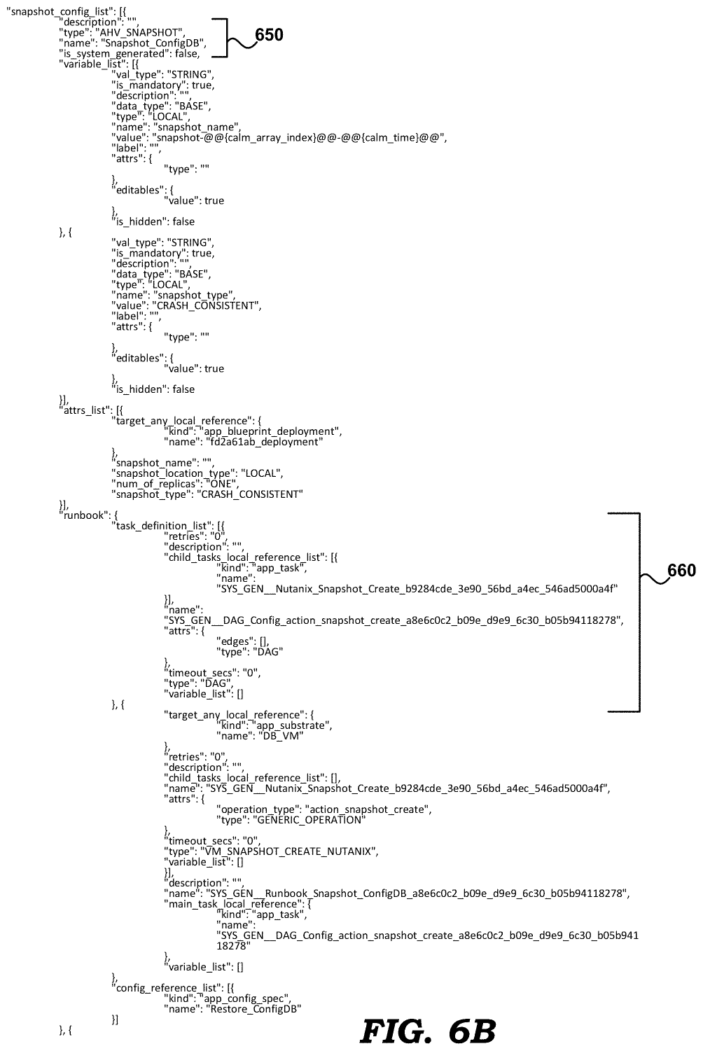

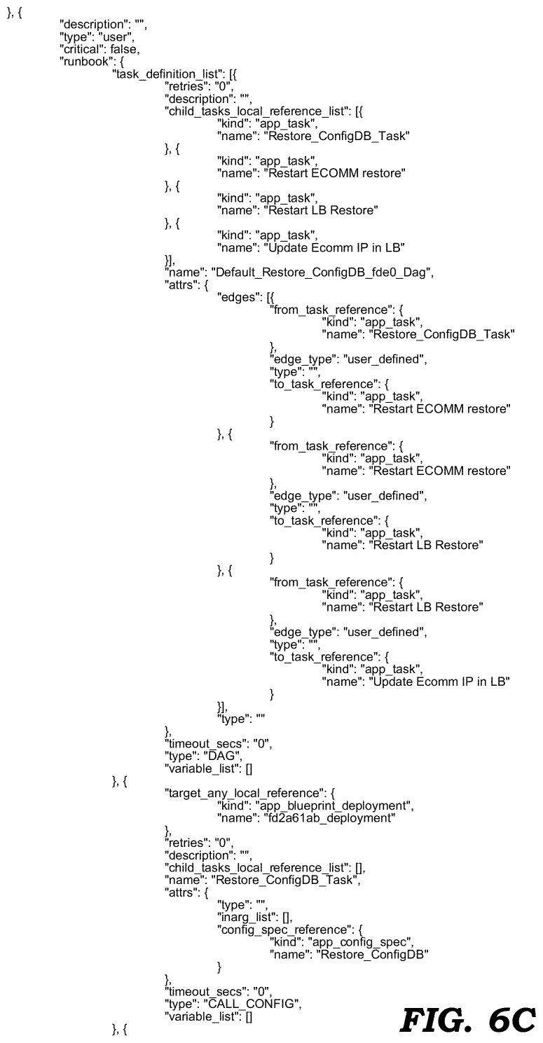

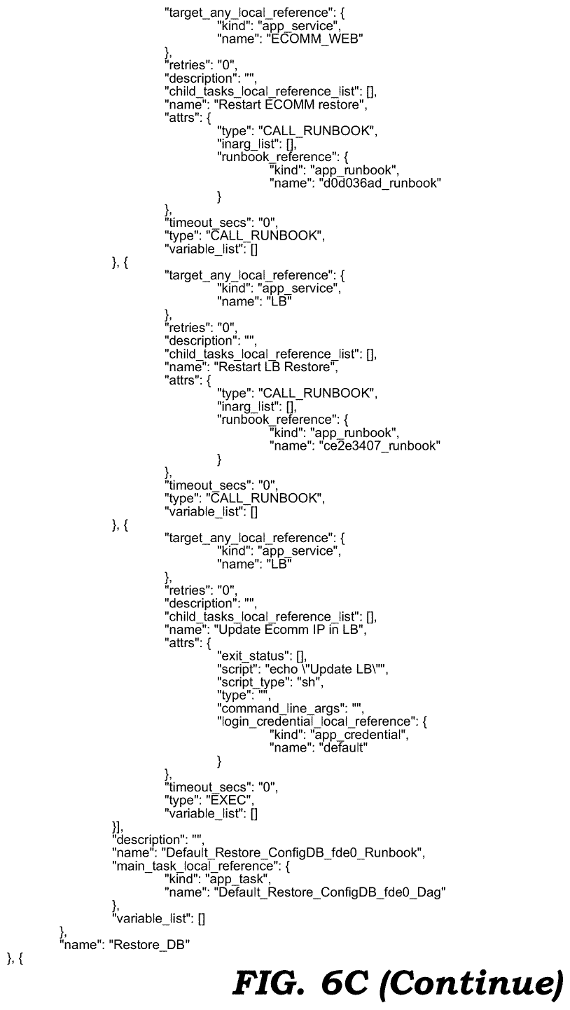

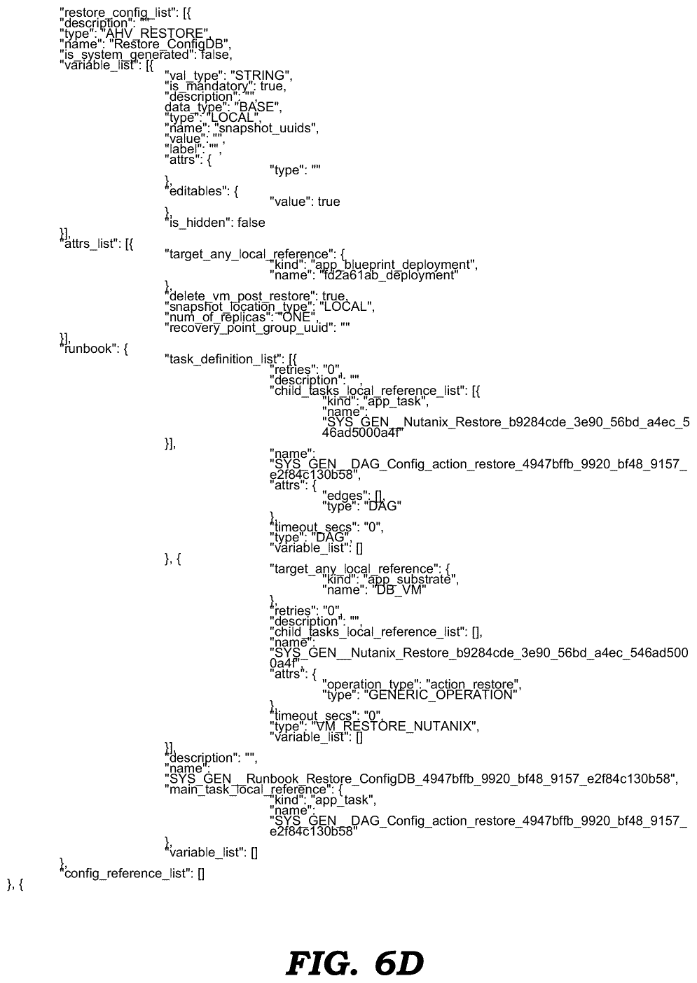

FIGS. 6A-6D illustrates the manner in which setup data for a user application is specified in one embodiment. For illustration, the setup data is shown specified according to JSON (JavaScript Object Notation). However, in alternative embodiments, the setup data may be maintained according to other data formats (such as extensible markup language (XML), etc.) and/or using other data structures (such as database tables, lists, trees, etc.), as will be apparent to one skilled in the relevant arts by reading the disclosure herein.

An example setup data for the user application “Ecom_Prod_Example” is shown in Appendix A of the provisional application. The setup data of Appendix A of the provisional application may be generated in response to the user specifying the data using the user interfaces of FIGS. 4A-4B and 5A-5E. Some of the portions of the example setup data are reproduced in the Figures as well. Specifically, FIGS. 6A and 6B respectively depicting lines 2170-2325 and lines 2917-3010 of Appendix A specify the details of the actions to be performed upon receipt of a manual snapshot command for the component “DB”. FIGS. 6C and 6D respectively depicting lines 2325-2480 and 2768-2842 of Appendix A specify the details of the actions to be performed upon receipt of a manual restore command for the component “DB”. Some of the portions of the setup data are described in detail below.

In FIG. 6A, data portion 610 specifies the set of actions/tasks to be performed for manual snapshot of component “DB”. Data portion 620 specifies the edges/arrows/dependencies among the actions/tasks. Data portion 630 specifies any external scripts to be executed as part of the actions/tasks. Data portion 640 indicates that the set of actions is to be referred to (in other parts of the setup data) as “Snapshot_ConfigDB”. The snapshot configuration “Snapshot_DB” of data portions 610, 620, 630 and 640 may be generated in response to the user providing the inputs noted above with respect to FIG. 5C. In FIG. 6B, data portion 650 refers to “Snapshot_ConfigDB” indicating that the corresponding set of actions are to be performed, and data portion 660 indicates that a snapshot of the component (here “DB”) is to be created.

Similarly, FIG. 6C specifies the set of actions/tasks to be performed for manual restore of component “DB”, the edges/arrows/dependencies among the actions/tasks, any external scripts to be executed as part of the actions/tasks and the reference name as “Restore_ConfigDB”. The restore configuration “Restore_DB” of FIG. 6C may be generated in response to the user providing the inputs noted above with respect to FIG. 5D. In FIG. 6D, reference is made to “Restore_ConfigDB” indicating that the corresponding set of actions are to be performed, and that a restore of the component (here “DB”) is to be performed.

Thus, a user (application deployer) is facilitated to specify a desired setup data specifying the corresponding set of actions to be performed upon receipt of manual snapshot/restore commands for components of a user application. An operator may thereafter send commands for performance of the manual snapshot and restore as described in detail below.

### 8. Manual Snapshot and Restore

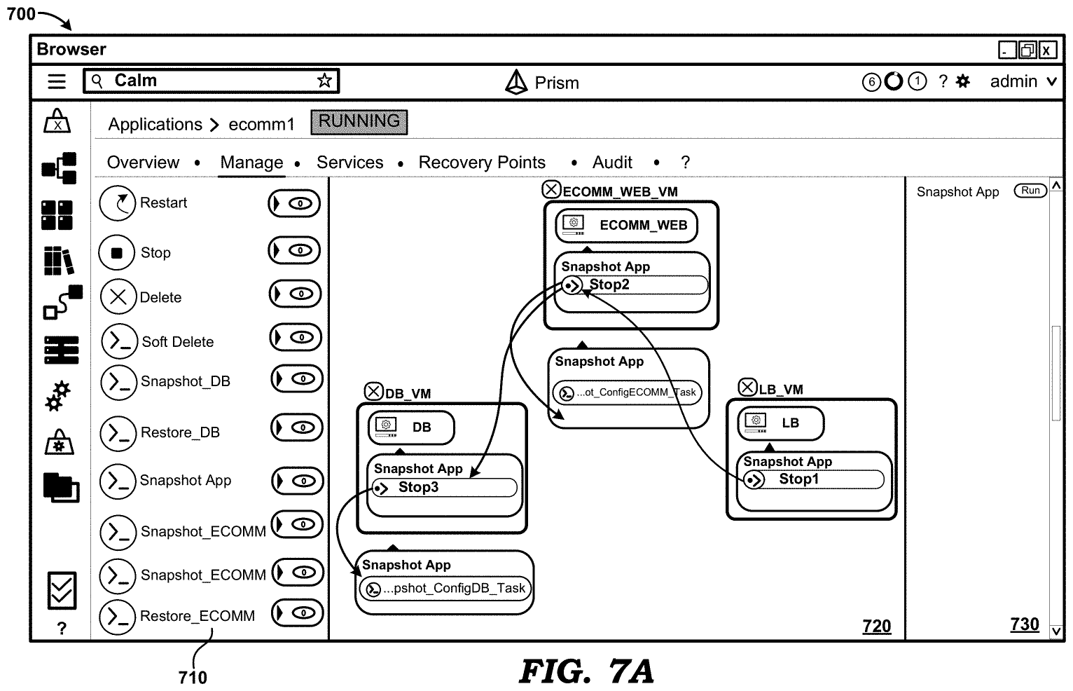

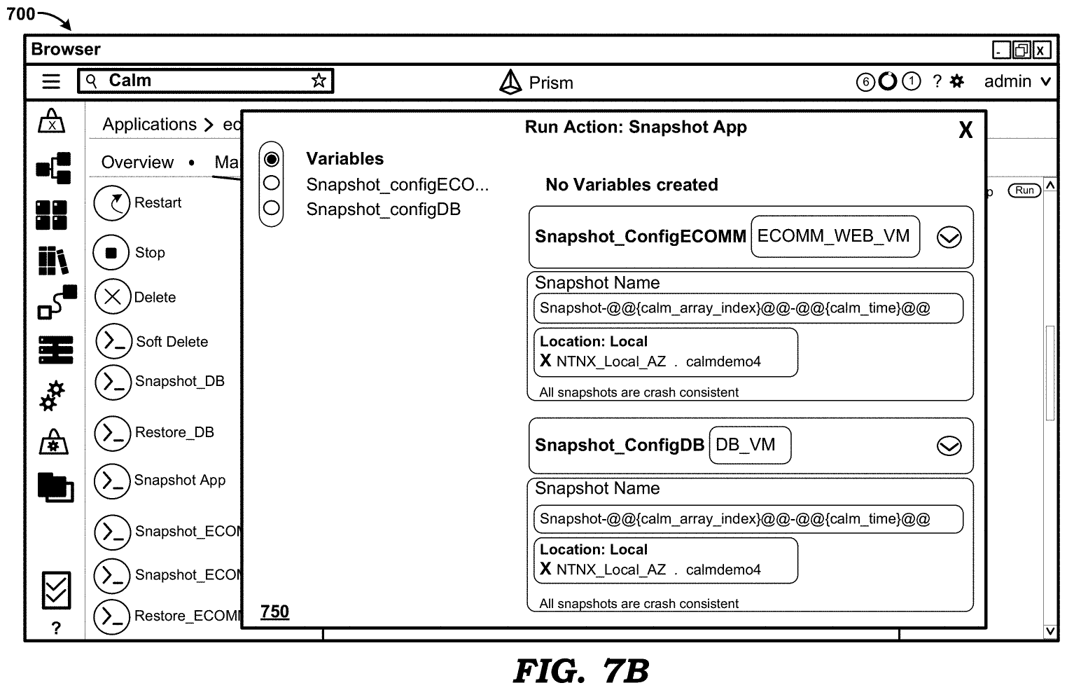

FIGS. 7A and 7B illustrates the manner in which a user (operator) is facilitated to perform manual snapshot and restore of components of a user application in one embodiment. Each of the Figures is described in detail below.

In FIG. 7A, display area 700 depicts a sample user interface provided to an operator of the user application “Ecom_Prod_Example”. Display area 710 depicts the various administrative commands available to the operator such as “Snapshot_DB”, “Restore_DB”, “Snapshot_App” (for manual snapshot of the whole application), etc. Display area 730 indicates that the operator has selected the manual snapshot command “Snapshot_App”, and accordingly display area 720 displays the various components of the user application and corresponding actions as previously configured by the application deployer as part of the setup data. The operator may select/click the “Run” option in display area 730 to execute the manual snapshot of the whole application.

In FIG. 7B, display area 750 is a pop-up shown when the user selects/clicks the “Run” option in display area 730. It may be appreciated that display area 750 indicates that the manual snapshot of the application causes the performance of the manual snapshot of the various application components such as ECOMM and DB in accordance with the setup data shown above. In other words, for the manual snapshot of component DB, management server 150 performs the actions shown in data portions 610, 620 and 630 of setup data along with capturing the current state of the DB component. In one embodiment, management server 150 constructs a script to perform the actions shown in data portions 610, 620 and 630 of setup data and/or capturing the current state of the DB component, and then executes the script to perform the first set of actions (along with capturing the current state of the DB component) on the respective virtual machines (LB_VM, ECOMM_WEB_VM and DB_VM).

The operator may similarly perform the manual restore of the DB component or any other component of the user application. In one embodiment, all the actions of the set of actions are performed before performing the capturing of the current state of the component when a manual snapshot command is received. When a manual restore command is received, all the actions of the corresponding set of actions are performed after performing the restoring of the component to the previous state.

Thus, aspects of the present disclosure shield the operators from the details of the architecture of the user application. Application deployers are enabled to create runbooks (sequence of tasks) to take snapshots, run external scripts, restore and execute complex orchestration across the user application. When doing this, the entire infrastructure is abstracted out. These runbooks can further be controlled using policies that the application deployer can set up.

It may be appreciated that previously, application deployers cannot create policies that are in the context of an application, which can span across different clusters and virtual machines. They would have to go into clusters to define certain policies which are only scoped to that cluster, do manual overview and cleanup of snapshots. The instant approach clearly now enables the application deployer to define via actions on how the entire application can be snapshotted and restored, along with any scripts or orchestration that the application needs.

The instant approach also solves the problem of security, as only the users (operators) who have access to the application can run the snapshot/restore actions. With snapshot/restore for applications, application deployers have the capability to define policies, give infra level capabilities to end users without compromising security, without manual intervention or monitoring.

Furthermore, operators can now have access to snapshot/restore capabilities on the user application. Now because of the policies that the IT administrator has enforced, the operator does not have to worry about security of their own application and also all the various permissions and approvals that they will require for infrastructure level operations. The operators can also share their snapshot/restore actions with other users with their same permission and access to the user application. Thus, application deployers are provided with a single plane of control to enforce policies across infrastructures and applications.

It should be further appreciated that the features described above can be implemented in various embodiments as a desired combination of one or more of hardware, software, and firmware. The description is continued with respect to an embodiment in which various features are operative when the software instructions described above are executed.

### 9. Digital Processing System

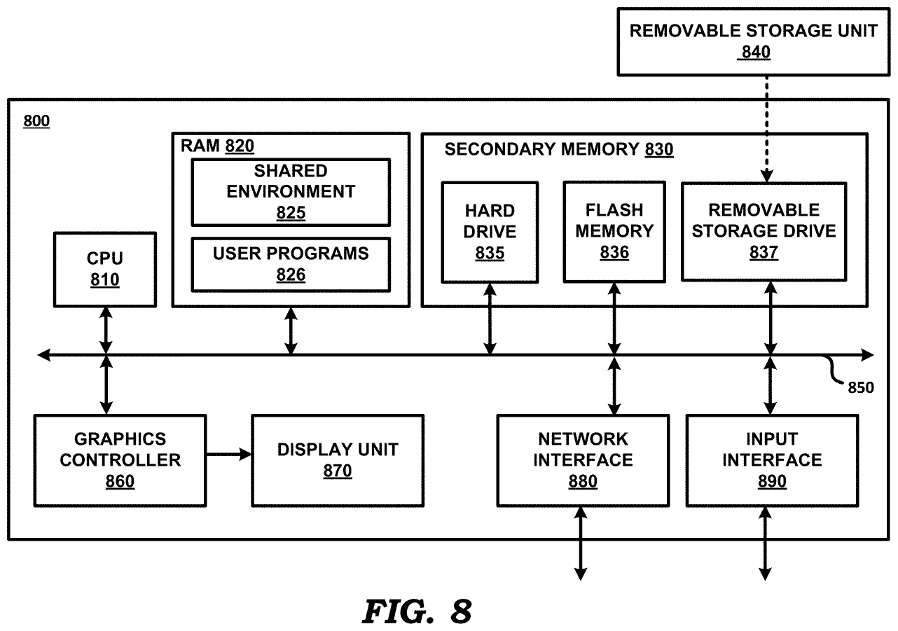

FIG. 8 is a block diagram illustrating the details of digital processing system 800 in which various aspects of the present disclosure are operative by execution of appropriate executable modules. Digital processing system 800 may correspond to management server 150.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and/or other user programs 826 (such as other applications, DBMS, etc.). In addition to shared environment 825, RAM 820 may contain other software programs such as device drivers, virtual machines, etc., which provide a (common) run time environment for execution of other/user programs.

Graphics controller 860 generates display signals (e.g., in RGB format) to display unit 870 based on data/instructions received from CPU 810. Display unit 870 contains a display screen to display the images defined by the display signals (e.g., portions of the user interfaces of FIGS. 4A-4B, 5A-5E and 7A-7B). Input interface 890 may correspond to a keyboard and a pointing device (e.g., touch-pad, mouse) and may be used to provide inputs (e.g., for providing inputs to the user interfaces of FIGS. 4A-4B, 5A-5E and 7A-7B). Network interface 880 provides connectivity to a network (e.g., using Internet Protocol), and may be used to communicate with other systems (of FIG. 1) connected to the networks (120).

Secondary memory 830 may contain hard drive 835, flash memory 836, and removable storage drive 837. Secondary memory 830 may store the data (for example, data portions shown in FIGS. 6A-6D and Appendix A) and software instructions (for example, for performing the actions of FIG. 3, for implementing the various features of the present disclosure, etc.), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 10. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method comprising:
receiving setup data specifying a first set of actions to be performed upon receipt of a manual snapshot command with respect to a component of a user application hosted on a cloud infrastructure;
receiving, after receipt of the setup data, the manual snapshot command to capture a current state of the component;
performing the first set of actions along with capturing the current state of the component.

2. The method of claim 1, wherein the user application comprises a plurality of components including the component, wherein each component of the plurality of components is hosted on respective virtual machine of a plurality of virtual machines in the cloud infrastructure,
wherein a first action of the first set of actions is performed with respect to a first component of the plurality of components, the first component being different from the component.

3. The method of claim 2, wherein a second action of the first set of actions is performed with respect to a second component of the plurality of components, the second component being different from the first component and the component,
wherein the performing comprises executing a script to perform the first set of actions, including the first action and the second action on the respective virtual machines of the plurality of virtual machines.

4. The method of claim 1, wherein the setup data is comprised in a blueprint file provided by an application deployer and the manual snapshot command is received from an operator.

5. The method of claim 1, wherein the setup data further specifies a second set of actions to be performed upon receipt of a manual restore command with respect to the component, the method further comprising:
receiving, after receipt of the setup data, the manual restore command to restore the component to a previous state captured in a corresponding snapshot;
performing the second set of actions along with restoring the component to the previous state.

6. The method of claim 5, wherein all of the first set of actions are performed before performing the capturing of the current state of the component,
wherein all of the second set of actions are performed after performing the restoring of the component to the previous state.

7. The method of claim 6, wherein the component is the user application.

8. A non-transitory machine-readable medium storing one or more sequences of instructions, wherein execution of the one or more instructions by one or more processors contained in a digital processing system causes the digital processing system to perform the actions of:
receiving setup data specifying a first set of actions to be performed upon receipt of a manual snapshot command with respect to a component of a user application hosted on a cloud infrastructure;
receiving, after receipt of the setup data, the manual snapshot command to capture a current state of the component;
performing the first set of actions along with capturing the current state of the component.

9. The non-transitory machine-readable medium of claim 8, wherein the user application comprises a plurality of components including the component, wherein each component of the plurality of components is hosted on respective virtual machine of a plurality of virtual machines in the cloud infrastructure,
wherein a first action of the first set of actions is performed with respect to a first component of the plurality of components, the first component being different from the component.

10. The non-transitory machine-readable medium of claim 9, wherein a second action of the first set of actions is performed with respect to a second component of the plurality of components, the second component being different from the first component and the component,
wherein the performing comprises one or more instructions for executing a script to perform the first set of actions, including the first action and the second action on the respective virtual machines of the plurality of virtual machines.

11. The non-transitory machine-readable medium of claim 8, wherein the setup data is comprised in a blueprint file provided by an application deployer and the manual snapshot command is received from an operator.

12. The non-transitory machine-readable medium of claim 8, wherein the setup data further specifies a second set of actions to be performed upon receipt of a manual restore command with respect to the component, further comprising one or more instructions for:
receiving, after receipt of the setup data, the manual restore command to restore the component to a previous state captured in a corresponding snapshot;
performing the second set of actions along with restoring the component to the previous state.

13. The non-transitory machine-readable medium of claim 12, wherein all of the first set of actions are performed before performing the capturing of the current state of the component,
wherein all of the second set of actions are performed after performing the restoring of the component to the previous state.

14. The non-transitory machine-readable medium of claim 13, wherein the component is the user application.

15. A digital processing system comprising:
a random access memory (RAM) to store instructions; and
one or more processors to retrieve and execute the instructions, wherein execution of the instructions causes the digital processing system to perform the actions of:
receiving setup data specifying a first set of actions to be performed upon receipt of a manual snapshot command with respect to a component of a user application hosted on a cloud infrastructure;
receiving, after receipt of the setup data, the manual snapshot command to capture a current state of the component;
performing the first set of actions along with capturing the current state of the component.

16. The digital processing system of claim 15, wherein the user application comprises a plurality of components including the component, wherein each component of the plurality of components is hosted on respective virtual machine of a plurality of virtual machines in the cloud infrastructure,
wherein a first action of the first set of actions is performed with respect to a first component of the plurality of components, the first component being different from the component.

17. The digital processing system of claim 16, wherein a second action of the first set of actions is performed with respect to a second component of the plurality of components, the second component being different from the first component and the component,
wherein for the performing, the digital processing system performs the actions of executing a script to perform the first set of actions, including the first action and the second action on the respective virtual machines of the plurality of virtual machines.

18. The digital processing system of claim 15, wherein the setup data is comprised in a blueprint file provided by an application deployer and the manual snapshot command is received from an operator.

19. The digital processing system of claim 15, wherein the setup data further specifies a second set of actions to be performed upon receipt of a manual restore command with respect to the component, the digital processing system further performing the actions of:
receiving, after receipt of the setup data, the manual restore command to restore the component to a previous state captured in a corresponding snapshot;
performing the second set of actions along with restoring the component to the previous state.

20. The digital processing system of claim 19, wherein all of the first set of actions are performed before performing the capturing of the current state of the component,
wherein all of the second set of actions are performed after performing the restoring of the component to the previous state.
